(19) United States
(12) Patent Application Publication
(10) Pub. No.: US 2004/0183247 A1
(43) Pub. Date: Sep. 23, 2004

(54) Cover sheet applicator

(76) Inventors: Ben J. Rosenthal, (US); Gregory Starr, Buffalo Grove, IL (US); Lorelai G. Rosenthal, (US)

Correspondence Address: OLSON & HIERL, LTD., 36th Floor, 20 North Wacker Drive, Chicago, IL, 60606, US

(21) Appl. No.: 10/393,135

(22) Filed: Mar. 20, 2003

(51) Int. Cl. B42B 2/00

(52) U.S. Cl. 270/52.14

(57) ABSTRACT

A cover sheet applicator for applying a cover sheet from a roll, for example, paper or plastic, to a sheet of material, for example, glass or screen printed adhesives. The applicator comprises a frame and a first conveyor for receiving a sheet of material to be covered. Cover material is drawn from the roll by drive rollers. A cutting mechanism cuts the cover material to a predetermined length to form the cover sheet. The cover sheet is received and retained on a vacuum conveyor which is inclined with respect to the first conveyor, for example, an endless belt. A control is provided to sequence the operation of the first conveyor, the cutting mechanism and the vacuum conveyor. When the lead edge of the cover sheet and the sheet of material are aligned, the vacuum is released and upon further advance of the sheet of material, the cover sheet is applied to the top of the sheet of material.

### FIELD OF THE INVENTION

This invention relates to a cover sheet applicator and, more particularly, to an applicator for applying sheet material cut to predetermined size from a roll to a sheet of material.

### BACKGROUND OF THE INVENTION

There are a number of applications where it is desired to cover a sheet of material with an overlay material. For example, it may be desired to protect one sheet of glass from another sheet of glass by putting a sheet of paper or plastic or the like protective material between them. One sheet of glass may be fed on a conveyor and an operator may manually place a pre cut sheet of paper or the like on top of the sheet of glass. Alternately, a pick and place machine can be used in place of the operator to place a pre cut sheet of paper on the sheet of glass. The use of pre cut sheets is relatively expensive. The use of manual labor or the use of a pick and place machine is rather slow and costly. Another application is applying release sheets to screen printed adhesives. Presently, the release sheets are precut and often applied manually to the sheet of screen printed adhesives. Material and labor costs are relatively high.

Various attempts are known to apply one sheet of material to another. Schieven U.S. Pat. No. 3,649,001 shows a device for holding a plurality of sheets in a given superimposed relationship on a conveyor by vacuum.

Kuehnert U.S. Pat. No. 4,722,256 pertains to a method and apparatus for gripping and cutting a lamination film. The gripper mechanism is relatively complicated and includes vacuum grippers which are horizontally displaceable and fixable along a cross strut on the frame. The gripper mechanism is movable up and down along vertical guide rods.

The Coenen U.S. Pat. No. 6,245,168 relates to a process and apparatus for controllably registering two continuously moving layers of material. The Coenen patent reveals a rather elaborate control which relies on reference marks on the respective layers of material.

The Murano Patent Publication 2002/018708 pertains to a metallized composite including a thermoplastic sheet and at least one discontinuous layer of metal within the thermoplastic sheet. The discontinuous metal layer can be disposed between two thermoplastic layers that are bound together, such as by melting the layers together, pressing, or by use of an adhesive.

None of these prior art references suggest the present invention.

An object of the present invention is to provide a cover sheet applicator that will cut the cover sheet from a roll of material to a desired length and automatically apply the cut cover sheet to a sheet of material.

Another object of the present invention is to provide a cover sheet applicator to match material in roll form to material in sheet form.

A further object of the present invention is to provide a cover sheet applicator that will significantly reduce labor and material costs as compared to present manual methods of applying a discrete cover sheet over a discrete under sheet.

Yet another object of the present invention is to cut a length of overlay or cover material from a roll and match the lead edge of the cover material to the lead edge of an underlying sheet by means including a vacuum conveyor, and then advancing both the cover sheet and the underlying sheet so as to cover the underlying sheet.

Other objects and advantages of the present invention will be made apparent hereinafter.

### BRIEF DESCRIPTION OF THE DRAWING

Thee is shown in the attached drawing a presently preferred embodiments of the present invention wherein like numerals in the various views refer to like elements and wherein

FIG. 1 is a side view of the cover sheet applicator of the present invention;

FIG. 2 is a plan view of the cover sheet applicator of the present invention;

FIG. 3 is a detail view of the vacuum conveyor of the cover sheet applicator: and

FIG. 4 is a cross-section view of the vacuum conveyor take generally along the line 4-4 of FIG. 3.

### DETAILED DESCRIPTION OF THE PRESENT INVENTION

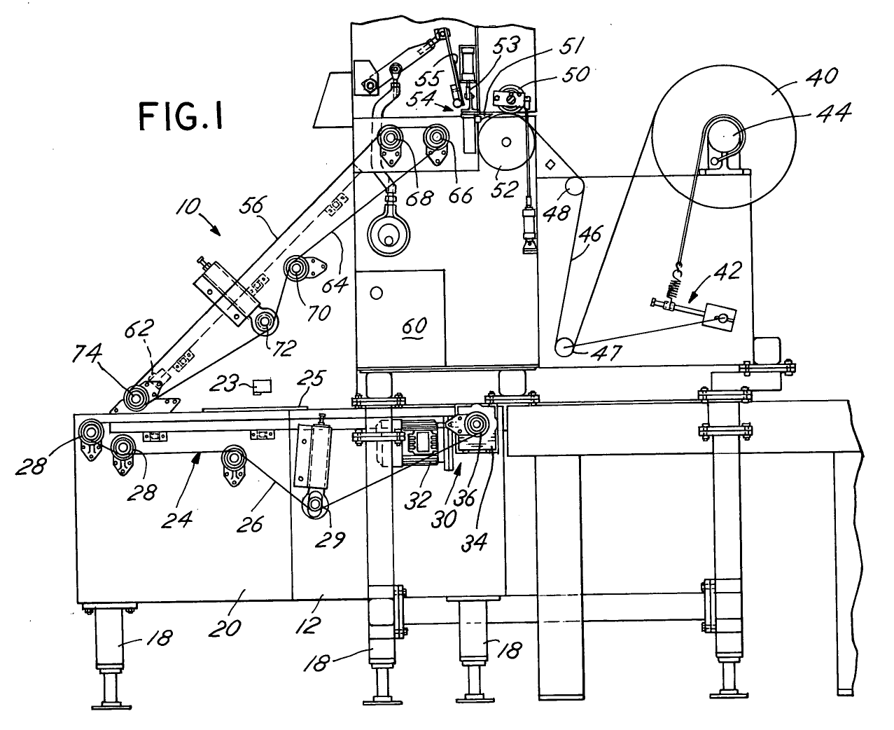

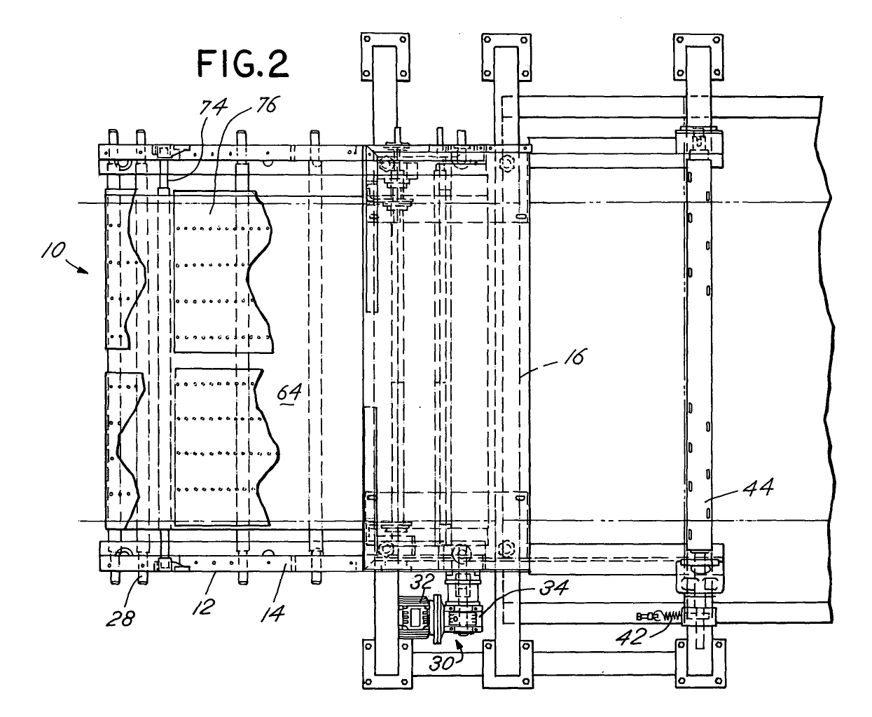

The overall cover sheet applicator 10 of the present invention will be described with reference to FIGS. 1 and 2. The cover sheet applicator 10 includes a frame 12 that supports the operating components of the applicator 10. The frame 12 is generally rectangular and includes longitudinal supports 14 suitably interconnected with transverse supports 16. As shown, the frame 12 includes support legs 18. Panels 20 may be provided to cover the sides of the frame 12.

A first conveyor 24 is supported on the frame 12 for receiving a sheet of material 25 and moving to the left in FIG. 1 to a predetermined position. The first conveyor 24 may comprise an endless belt 26 trained over a plurality of support pulleys or sprockets 28. The endless belt 26 is driven by a suitable drive means 30, which includes a drive motor 32 and a gear reducer 34 carried on the frame 12. A support pulley or sprocket 36 connected to the shaft from the gear reducer 34 is operatively connected to the endless belt 26 for actuating same. An adjustable pulley or sprocket 29 is operatively connected to the belt 26 for adjusting the tension of the endless belt 26. A first sensor 23, for example, a photocell, is associated with the conveyor 24.

Carried on the frame 12 is a roll 40 of cover or overlay material. The overlay or cover material may be plastic, paper or the like depending upon the application. A tensioning mechanism of known design is provided to tension the shaft 44 supporting the roll to control the discharge of cover or overlay material from the roll. Cover or overlay material 46 passes from the roll 40 over idler pulleys 47 and 48 and between drive rollers 50, 52 to a cutting station 54. Transition plate 51 is positioned closely adjacent the drive rollers 50 and 52 for receiving the overlay or cover material 46 and guiding it to the cutting station 54. A clamp mechanism 53 is provided at the cutting station 54 and is actuated during operation to hold the overlay or cover material 46 to facilitate the cutting thereof by the knife or blade mechanism 55 at the cutting station 54. The knife or blade mechanism 55 may be considered to be cutting means. The cover or overlay material 46 passes through the cutting station 54 onto an inclined vacuum conveyor 56.

Control means 60 are provided on the frame 12 for sequencing the operation of the first conveyor 24, the cutting means 55, and the inclined vacuum conveyor 56.

A second sensor 62, for example, a photocell, is carried on the frame 12 and is disposed proximate the end of the inclined vacuum conveyor 56 for sensing a predetermined position of the lead edge of the overlay or cover material 46. The second sensor 62 will provide a signal to the control means 60 for stopping the advance of the overlay or cover material 46.

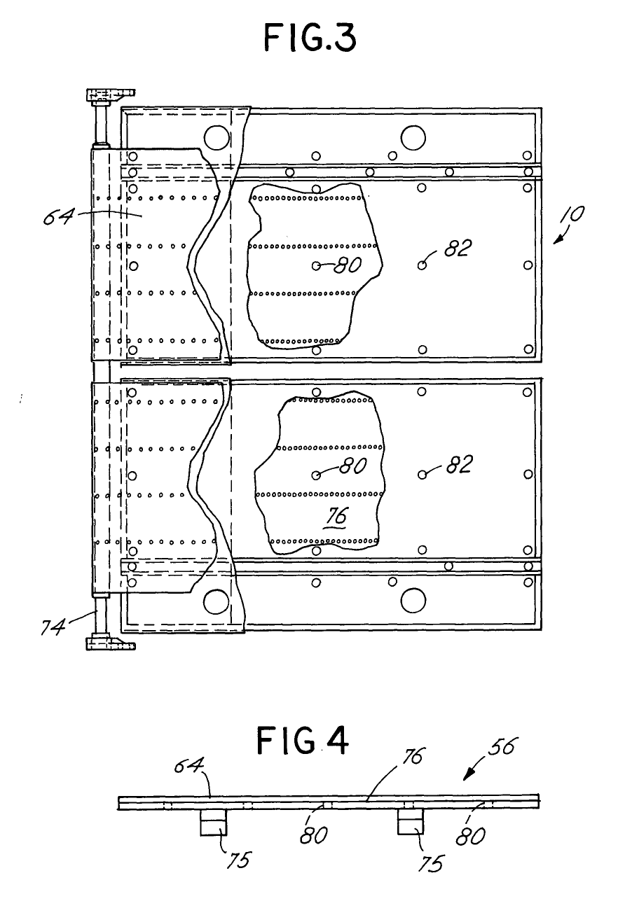

The inclined vacuum conveyor 56, as shown in FIGS. 1, 2, 3, and 4 comprises a belt 64 carried over a plurality of shafts 66, 68, 70, 72, 74. The upper run of the belt 64 passes over the top surface of the vacuum manifold 76, which is operatively connected to a source of vacuum through vacuum connections 75. The shaft 74 may be operatively connected to a drive source, for example, an electric drive motor, for rotating same. A plurality of longitudinally aligned holes or openings 80 are provided in the top surface of the vacuum manifold 76. Similarly, a plurality of aligned holes or openings 82 are provided through the belt 64. When the holes or openings 80 are in alignment over the openings 82, suction can be applied to the bottom of the overlay or cover material 46 to hold the overlay or cover material 46 in place on the belt 64. When the suction is released, the overlay or cover material 46 that is cut to a predetermined length can move onto the top of the sheet of material on the first conveyor 24.

In the inventive cover sheet applicator 10, a push button in the control means 60 is actuated. The control means 60 may be suitably programmed to cut a predetermined length, for example, the same length as the sheet 25 to be covered. Cover or overlay material 46 is drawn over the shafts 47 and 46 from the roll 40 by the cooperating drive rolls 50 and 52. The cover material 46 is fed over the transition plate 51 to the cutting station 54 and then onto the vacuum conveyor 56. When the lead edge of the cover material 46 reaches a predetermined position, the sensor 62 will send a signal to the control means 60. The control means 60 will stop the drive roll 50 and stop the feed of cover material. The cutting means 55 are actuated to cut the cover material 46 to a predetermined length, which may be the same as or different from the length of the first sheet, as desired for a particular application. When the sensor 62 senses the lead edge of the cut cover material 46, vacuum is provided to the vacuum manifold 76 and vacuum passing through the aligned openings 80 and 82 in the vacuum manifold 76 and the belt 64, respectively, will hold the cover material in place on the vacuum manifold 76. The sheet 25 to be covered is then fed by the first conveyor 24. When the second sensor 62 senses the alignment of the lead edges of the cover sheet and the first sheet, the vacuum will be released and the belt 64 will move the cover sheet onto the first sheet.

The present invention can be employed in a variety of applications. In one application a sheet of printed material, such as screen printed decals, would be provided with a cover material 46 of plastic or paper to prevent smearing of the ink or to prevent one sheet from sticking to the next. In another application, a plastic cover sheet can be provided over a sheet of glass to protect same from scratching. Other uses will become apparent to persons skilled in the art.

While there has been shown and described a presently preferred embodiment of the invention, lit will be apparent to persons skilled in the art that the invention may be otherwise embodied within the scope of the appended claims.

We claim:

1. A cover sheet applicator for applying a cover sheet from a roll to a sheet of material including a frame, a first conveyor on said frame for receiving sheet material to be covered and advancing the lead edge thereof to a first position, a roll on said frame for receiving cover material, drive means for feeding cover material from the roll, cutting means for cutting the cover material to a predetermined length to form a cover sheet, a vacuum conveyor disposed at an angle to the first conveyor on the frame for receiving and retaining said cover sheet in a predetermined position, and whereby, upon further advance of the sheet material and release of the vacuum, the cover sheet is automatically applied to the sheet material.

2. A cover sheet applicator as in claim 1, wherein the vacuum conveyor includes a belt movable over a vacuum manifold, whereby upon application of vacuum to the vacuum manifold, the cover sheet is held on the vacuum conveyor and upon release of the vacuum, the cover sheet is released from the vacuum conveyor.

3. A cover sheet applicator as in claim 2, including a control means for sequencing the operation of the first conveyor, the cutting means and the vacuum conveyor.

4. A cover sheet applicator as in claim 3, wherein the control means includes a sensor associated with the vacuum conveyor for stopping the drive means with the lead edge of the cover sheet at a predetermined position on the vacuum conveyor.

5. A cover sheet applicator as in claim 4, wherein the control means includes a second sensor for releasing the vacuum from the vacuum manifold when the lead edge of the cover sheet is aligned with the lead edge of the sheet material.

6. A cover sheet applicator for applying cover material from a roll to a sheet of material including means for feeding cover material from a roll, means for cutting the cover material to a predetermined length to form a cover sheet, means for positioning the lead edge of the cover sheet at a predetermined position on a vacuum conveyor, and means for applying vacuum to the vacuum conveyor to retain the cover sheet in said predetermined position, means for feeding a sheet of material to a first operating position wherein the lead edge of the cover sheet is disposed adjacent the lead edge of the sheet of material, and means for releasing the vacuum to the vacuum conveyor so that upon further advance of the sheet material, the cover sheet will automatically overlay the sheet of material.

7. A cover sheet applicator as in claim 6, wherein the sheet of material is rigid.

8. A cover sheet applicator as in claim 7, wherein the sheet of material is glass.

9. A cover sheet applicator as in claim 8, wherein the cover sheet is plastic.

10. A method of applying cover material from a roll to a sheet of material including the steps of feeding cover material from a roll, cutting the cover material to a predetermined length to form a cover sheet, positioning the lead edge of the cover sheet at a predetermined position on a vacuum conveyor and applying vacuum to the vacuum conveyor to retain the cover sheet in said predetermined position, feeding a sheet of material to a first operating position wherein the lead edge of the cover sheet is disposed adjacent the lead edge of the sheet of material, and releasing the vacuum to the vacuum conveyor so that upon further advance of the sheet of material, the cover sheet will automatically overlay the sheet of material.

11. The method of claim 10, wherein cover sheet is of a predetermined width and is cut to a length corresponding to the length of the sheet of material.

12. The method of claim 11, wherein the predetermined width of the cover sheet corresponds to the width of the sheet of material sheet.

13. The method of claim 10, including the step of applying the vacuum in response to sensing a predetermined position of the lead edge of the cover sheet.
